(19) United States
(12) Patent Application Publication
(10) Pub. No.: US 2025/0229525 A1
(43) Pub. Date: Jul. 17, 2025

(54) LIQUID EJECTING DEVICE AND LIQUID EJECTING METHOD

(71) Applicant: SEIKO EPSON CORPORATION, TOKYO (JP)

(72) Inventors: Hiroshi SHIOBARA, MATSUMOTO-SHI (JP); Koki MURAKAMI, AGEMATSU-MACHI (JP); Masato OGAWA, SHIOJIRI-SHI (JP); Yuki HARA, SHIOJIRI-SHI (JP); Masaki SHIMOMURA, Matsumoto-shi (JP); Hiroyuki MAEDA, MATSUMOTO-SHI (JP); Shintaro KOMURO, MATSUMOTO-SHI (JP); Koji HARA, MATSUMOTO-SHI (JP)

(21) Appl. No.: 19/023,500

(22) Filed: Jan. 16, 2025

(30) Foreign Application Priority Data
Jan. 16, 2024 (JP) 2024-004397

(51) Int. Cl. B41J 2/045; B41J 2/21

(52) U.S. Cl. CPC B41J 2/04566; B41J 2/04563; B41J 2/2125

(57) ABSTRACT

A control unit of a liquid ejecting device can perform, as control for ejecting liquid from a liquid ejecting unit, a first ejection control for performing recording on a medium, a second ejection control being a different control from the first ejection control for performing maintenance of the liquid ejecting unit, and a third ejection control being a different control from the first ejection control and the second ejection control for turning the liquid into mist between the liquid ejecting unit and a support portion, and the control unit further performs, when performing the third ejection control, the third ejection control before feeding the medium between the support portion and the liquid ejecting unit.

The present application is based on, and claims priority from JP Application Serial Number 2024-004397, filed Jan. 16, 2024, the disclosure of which is hereby incorporated by reference herein in its entirety.

### BACKGROUND

### 1. Technical Field

The present disclosure relates to a liquid ejecting device that performs recording by ejecting liquid onto a medium. Further, the present disclosure relates to a liquid ejecting method for the liquid ejecting device.

### 2. Related Art

An ink-jet recording device described in JP 2015-24612 A includes an ejecting unit that ejects a transparent liquid containing at least water onto a sheet separately from a recording head that performs recording on the sheet for the purpose of suppressing clogging of nozzles due to paper dust.

As in the ink-jet recording device disclosed in JP 2015-24612 A, in a configuration in which a liquid containing water is directly ejected onto a sheet to suppress scattering of paper dust, there is a risk that the sheet excessively absorbs the water to cause waving or wrinkling, which adversely affects recording quality. In addition, provision of an ejecting unit for ejecting a transparent liquid containing at least water onto a sheet separately from a recording head for performing recording on the sheet leads to an increase in size and cost of a device.

### SUMMARY

A liquid ejecting device according to the present disclosure for solving the above-described problems includes a support portion configured to support a medium, a liquid ejecting unit including a plurality of nozzles from which liquid is ejected onto the medium supported by the support portion, a transport unit configured to transport the medium between the support portion and the liquid ejecting unit, and a control unit configured to control the liquid ejecting unit and the transport unit, wherein the control unit is configured to perform, as control for ejecting the liquid from the liquid ejecting unit, a first ejection control for performing recording on the medium, a second ejection for performing maintenance of the liquid ejecting unit, the second ejection control being a different control from the first ejection control, and a third ejection control for turning the liquid into mist between the liquid ejecting unit and the support portion, the third ejection control being a different control from the first ejection control and the second ejection control, and the control unit is configured to further performs, when performing the third ejection control, the third ejection control before feeding the medium between the support portion and the liquid ejecting unit.

A liquid ejecting method for the liquid ejecting device according to the present disclosure is a liquid ejecting method for a liquid ejecting device including a support portion that supports a medium, a liquid ejecting unit including a plurality of nozzles from which liquid is ejected onto the medium supported by the support portion, and a transport unit that transports the medium between the support portion and the liquid ejecting unit, the liquid ejecting method being configured to perform, as processing for ejecting the liquid from the liquid ejecting unit, first ejection processing for performing recording on the medium, second ejection processing being different processing from the first ejection processing for performing maintenance of the liquid ejecting unit, and third ejection processing being different processing from the first ejection processing and the second ejection processing for turning the liquid into mist between the liquid ejecting unit and the support portion, wherein when the third ejection processing is performed, the third ejection processing is performed before the medium is fed between the support portion and the liquid ejecting unit.

### BRIEF DESCRIPTION OF THE DRAWINGS

FIG. 1 is a diagram illustrating medium transport paths of a printer.

FIG. 2 is a diagram illustrating the medium transport paths of the printer.

FIG. 3 is a block diagram illustrating a part of a control system of the printer.

FIG. 4 is a flowchart illustrating a flow of maintenance operation.

FIG. 5 is a diagram schematically illustrating ink droplets ejected by a first ejection control.

FIG. 6 is a diagram schematically illustrating ink mist generated by a third ejection control.

FIG. 7 is a flowchart illustrating processing performed when a control unit receives recorded data.

FIG. 8 is a diagram showing a relationship between threshold value of humidity and temperature.

### DESCRIPTION OF EMBODIMENTS

Hereinafter, the present disclosure will be described in brief.

A liquid ejecting device according to a first aspect includes a support portion configured to support a medium, a liquid ejecting unit including a plurality of nozzles from which liquid is ejected onto the medium supported by the support portion, a transport unit configured to transport the medium between the support portion and the liquid ejecting unit, and a control unit configured to control the liquid ejecting unit and the transport unit, wherein the control unit is configured to perform, as control for ejecting the liquid from the liquid ejecting unit, a first ejection control for performing recording on the medium, a second ejection control for performing maintenance of the liquid ejecting unit, the second ejection control being a different control from the first ejection control, and a third ejection control for turning the liquid into mist between the liquid ejecting unit and the support portion, the third ejection control being a different control from the first ejection control and the second ejection control, and the control unit is configured to further performs, when performing the third ejection control, the third ejection control before feeding the medium between the support portion and the liquid ejecting unit.

According to the aspect, it is possible to increase a humidity above the support portion by the third ejection control, and thus it is possible to prevent minute matter adhering to the medium from flying up and adhering to the nozzle. Then, a configuration for ejecting liquid separately from the liquid ejecting unit in order to obtain such an effect is not necessary, and thus it is possible to suppress an increase in size and cost of the device.

Examples of the minute matter include dust and the like, and paper dust when the medium is paper.

A second aspect is an aspect dependent on the first aspect, including a humidity detector configured to detect a humidity inside the device, wherein the control unit performs the third ejection control when a humidity acquired by the humidity detector is lower than a predetermined threshold value.

According to the aspect, the third ejection control is not performed when the humidity exceeds the threshold value, that is, in a high humidity environment in which minute matter adhering to the medium is unlikely to fly up, thus it is possible to suppress consumption of the liquid.

A third aspect is an aspect dependent on the first aspect, wherein the control unit is configured to switch between liquid ejection for achieving a first quality and liquid ejection for achieving a second quality higher in definition than the first quality when performing the first ejection control, and additionally the control unit does not perform the third ejection control when achieving the first quality, and performs the third ejection control when achieving the second quality.

In a case where the second quality being relatively higher in definition than the first quality is achieved, when dot omission occurs, the dot omission is likely to be conspicuous. According to the aspect, the third ejection control is not performed when the first quality is achieved, and the third ejection control is performed when the second quality is achieved, thus it is possible to appropriately achieve the second quality. In addition, since the third ejection control is not performed when the first quality is achieved, it is possible to suppress the consumption of the liquid.

A fourth aspect is an aspect dependent on the first aspect, wherein when performing recording on a first medium and a second medium following the first medium, the control unit performs the third ejection control in a state in which the first medium is located downstream from between the liquid ejecting unit and the support portion in a transport direction, and the second medium is located upstream from between the liquid ejecting unit and the support portion in the transport direction.

According to the aspect, when recording is performed on a plurality of the media, it is possible to prevent minute matter adhering to the media from flying up and adhering to the nozzle. Note that the aspect is not limited to the first aspect, and may be dependent on the second or third aspect.

A fifth aspect is an aspect dependent on the first aspect, wherein the control unit performs the third ejection control by using a time from when recorded data is received to when a leading end of the first fed medium reaches between the support portion and the liquid ejecting unit.

According to the aspect, the third ejection control is performed by using the time from when the recorded data is received to when the leading end of the first fed medium reaches between the support portion and the liquid ejecting unit, it is possible to suppress a decrease in recording throughput due to the performance of the third ejection control.

Note that the aspect is not limited to the first aspect, and may be dependent on any of the second to fourth aspects.

A sixth aspect is an aspect dependent on any one of the first to fifth aspects, wherein a droplet ejected in the third ejection control is smaller than a droplet ejected in the first ejection control and a droplet ejected in the second ejection control.

According to the aspect, the liquid droplet ejected in the third ejection control is smaller than the droplet ejected in the first ejection control and the droplet ejected in the second ejection control, it is possible to appropriately increase the humidity above the support portion when the third ejection control is performed.

A seventh aspect is an aspect dependent on the first aspect configured such that an interval between the liquid ejecting unit and the support portion is adjustable under control of the control unit, wherein the control unit sets the interval when performing the third ejection control to be larger than the interval when performing the first ejection control.

According to the aspect, the control unit sets the interval when performing the third ejection control to be larger than the interval when performing the first ejection control, thus a droplet is easily turned into mist between the liquid ejecting unit and the support portion, and it is possible to appropriately increase the humidity above the support portion.

Note that the aspect is not limited to the first aspect, and may be dependent on any of the second to sixth aspects.

An eighth aspect is an aspect dependent on the second aspect, including a temperature detector configured to detect a temperature inside the device, wherein the threshold value when the temperature is a first temperature is defined as a first threshold value, the threshold value when the temperature is higher than the first temperature is defined as a second threshold value, and the first threshold value is lower than the second threshold value, and the control unit uses the threshold value according to the temperature detected by the temperature detector.

Since an amount of moisture contained in air increases as temperature increases even at the same relative humidity, a need for humidification decreases as the temperature increases. In the aspect, since the first threshold value is lower than the second threshold value, it is possible to suppress unnecessary humidification and to suppress a liquid consumption amount.

Note that the aspect is not limited to the second aspect, and may be dependent on any of the third to seventh aspects that is an aspect including the configuration of the second aspect.

A ninth aspect is an aspect dependent on the first aspect, including a humidity detector configured to detect a humidity inside the device, wherein a liquid ejection amount in the third ejection control when the humidity is a first humidity is defined as a first ejection amount, a liquid ejection amount in the third ejection control when the humidity is a second humidity lower than the first humidity is defined as a second ejection amount, and the second ejection amount is larger than the first ejection amount, and the control unit uses the liquid ejection amount according to the humidity detected by the humidity detector in the third ejection control.

According to the aspect, the control unit uses the liquid ejection amount according to the humidity detected by the humidity detector in the third ejection control, thus the appropriate liquid ejection amount according to the humidity is used. Accordingly, the humidity above the support portion can be appropriately increased.

Note that the aspect is not limited to the first aspect, and may be dependent on any of the second to eighth aspects.

A tenth aspect is an aspect dependent on the first aspect, wherein the liquid ejecting unit is configured to eject a plurality of colors of liquid from the different nozzles, and the control unit performs the third ejection control by using a color of liquid having a largest moisture amount among the plurality of colors of liquid.

According to the aspect, the control unit performs the third ejection control by using the color of liquid having the largest moisture amount among the plurality of colors of liquid, thus it is possible to appropriately increase the humidity above the support portion.

Note that “having a large amount of moisture” means that a ratio of weight of water occupying per unit weight of liquid is large or a ratio of volume of water occupying per unit volume of liquid is large.

Note that the aspect is not limited to the first aspect, and may be dependent on any of the second to ninth aspects.

An eleventh aspect is an aspect dependent on the first aspect, wherein the liquid ejecting unit is configured to eject a plurality of colors of liquid including yellow from the different nozzles, and the control unit performs the third ejection control by using the yellow liquid among the plurality of colors of liquid.

When the liquid turns into mist, floats, and adheres to a component portion in the device, the portion is likely to be conspicuous as dirt. According to the aspect, the control unit performs the third ejection control by using the yellow liquid among the plurality of colors of liquid, thus even when the liquid adheres to a component portion in the device, it is possible to make the portion inconspicuous as dirt.

Note that the aspect is not limited to the first aspect, and may be dependent on any of the second to ninth aspects.

A twelfth aspect is an aspect dependent on the first aspect, wherein the control unit performs the third ejection control by using the nozzle having a long non-ejection period among the plurality of nozzles.

According to the aspect, the control unit performs the third ejection control by using the nozzle having the long non-ejection period among the plurality of nozzles, it is possible to suppress clogging of the nozzle.

Note that the aspect is not limited to the first aspect, and may be dependent on any of the third to ninth aspects.

A liquid ejecting method according to a thirteenth aspect is a liquid ejecting method for a liquid ejecting device including a support portion that supports a medium, a liquid ejecting unit including a plurality of nozzles from which liquid is ejected onto the medium supported by the support portion, and a transport unit that transports the medium between the support portion and the liquid ejecting unit, the liquid ejecting method being configured to perform, as processing of ejecting the liquid from the liquid ejecting unit, first ejection processing for performing recording on the medium, second ejection processing being different processing from the first ejection processing for performing maintenance of the liquid ejecting unit, and third ejection processing being different processing from the first ejection processing and the second ejection processing for turning the liquid into mist between the liquid ejecting unit and the support portion, wherein when the third ejection processing is performed, the third ejection processing is performed before the medium is fed between the support portion and the liquid ejecting unit.

According to the aspect, it is possible to increase the humidity above the support portion by the third ejection processing, and thus it is possible to prevent minute matter adhering to the medium from flying up and adhering to the nozzle. Then, a configuration for ejecting liquid separately from the liquid ejecting unit in order to obtain such an effect is not necessary, and thus it is possible to suppress an increase in size and cost of the device.

Hereinafter, the present disclosure will be described in detail.

Hereinafter, an inkjet printer 1 that performs recording by ejecting ink, which is an example of liquid, onto a medium, such as recording paper, will be described as an example of a liquid ejecting device. Hereinafter, the inkjet printer 1 will be abbreviated as the printer 1.

An X-Y-Z coordinate system illustrated in each figure is an orthogonal coordinate system, and a Y-axis direction is a width direction that intersects with a medium transport direction and is also a device depth direction. In the embodiment, among side surfaces constituting a periphery of a device body 2, a side surface in a +Y direction is a back surface, and a side surface in a −Y direction is a front surface.

An X-axis direction is a device width direction, and a +X direction is a left side and an −X direction is a right side as viewed by an operator of the printer 1. Further, the −X direction is a medium feed direction from each medium cassette, which will be described later.

A Z-axis direction is a vertical direction, that is, a device height direction, a +Z direction is an upward direction, and a-Z direction is a downward direction.

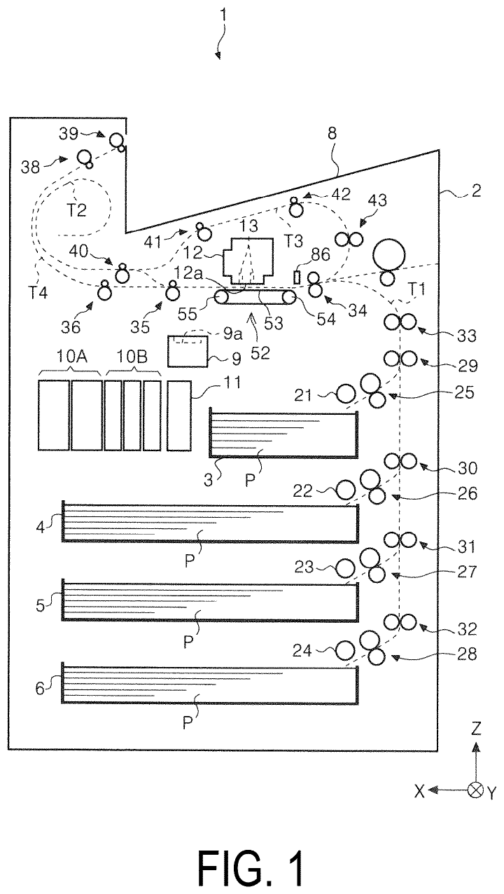

Hereinafter, a direction in which the medium is sent may be referred to as “downstream” and an opposite direction may be referred to as “upstream”. In FIG. 1, a medium transport path is illustrated by a dashed line. In the printer 1, the medium is transported through the medium transport path illustrated by the dashed line.

The printer 1 includes a plurality of the medium cassettes, specifically, a first medium cassette 3, a second medium cassette 4, a third medium cassette 5, and a fourth medium cassette 6 disposed in a vertical direction at a lower portion of the device body 2 including a line head 12 to be described later. A reference sign P denotes the medium accommodated in each medium cassette.

A pick roller that feeds the accommodated medium in the −X direction is provided for each medium cassette. Reference signs 21, 22, 23, and 24 denote pick rollers provided for the respective medium cassettes.

Further, a feed roller pair that feeds the medium sent out by the pick roller further downstream is provided for each medium cassette. Reference signs 25, 26, 27, and 28 denote feed roller pairs provided for the respective medium cassettes.

Hereinafter, unless otherwise specified, it is assumed that a “roller pair” includes a drive roller driven by a power source such as a motor, and a driven roller that rotates in a driven manner in contact with the drive roller.

A reference sign T1 denotes a transport path for the medium that is sent out from each medium cassette and reaches a transport roller pair 34. The medium sent out from the first medium cassette 3 receives feed force from transport roller pairs 29 and 33 and is sent to the transport roller pair 34. The medium sent out from the second medium cassette 4 receives feed force from a transport roller pair 30, the transport roller pairs 29, and 33 and is sent to the transport roller pair 34. The medium sent out from the third medium cassette 5 receives feed force from a transport roller pair 31, the transport roller pairs 30, 29, and 33 and is sent to the transport roller pair 34. The medium sent out from the fourth medium cassette 6 receives feed force from a transport roller pair 32, the transport roller pairs 31, 30, 29, and 33 and is sent to the transport roller pair 34.

The medium receiving feed force from the transport roller pair 34 is sent between the line head 12 which is an example of a liquid ejecting unit and a transporting belt 53, that is, a recording position facing the line head 12. The transport roller pair 34 constitutes a transport unit that transports the medium between the line head 12 and the transporting belt 53.

The line head 12 performs recording by ejecting ink, which is an example of liquid, onto a surface of the medium. The line head 12 is an ink ejection head in which a plurality of nozzles 13 that eject ink are disposed to cover an entire area in a width direction of the medium, and is configured as an ink ejection head that can perform recording over an entire width of the medium without moving in the width direction of the medium. However, the ink ejection head is not limited thereto, and may be a type that is mounted at a carriage and ejects ink while moving in the width direction of the medium.

A line head 14 according to the embodiment employs a piezo element, which is a piezoelectric element whose volume changes when a voltage is applied. A drive waveform of the piezo element is controlled so that a movement of a meniscus of the nozzle 13 can be controlled and a size and ejection speed of ejected ink droplets can be controlled.

In the embodiment, the plurality of nozzles 13 include a plurality of the nozzles 13 that eject a yellow ink, a plurality of the nozzles 13 that eject a magenta ink, a plurality of the nozzles 13 that eject a cyan ink, and a plurality of the nozzles 13 that eject the magenta ink.

Next, the transporting belt 53 is an endless belt that is wound around a first roller 54 and a second roller 55, and rotates when the first roller 54 is driven by a power source such as a motor. The medium is transported to the position facing the line head 12 while being adsorbed to a belt surface of the transporting belt 53.

The first roller 54, the second roller 55, and the transporting belt 53 constitute a belt unit 52. The belt unit 52 uses the first roller 54 as a rotation axis and is disposed to be rotatable by a power source (not illustrated). The belt unit 52 is an example of a support portion that supports the medium. Note that the support portion is not limited to the configuration including the transporting belt 53, and may be, for example, a platen that does not perform a medium transport function.

The medium in which recording is performed on a first side by the line head 12 is sent to either a transport roller pair 36 or a transport roller pair 40 by a transport roller pair 35 located downstream of the transporting belt 53. A path switching flap (not illustrated) is provided downstream of the transport roller pair 35, and the medium receiving feed force from the transport roller pair 35 is sent to any one of the transport roller pair 36 and the transport roller pair 40 by this path switching flap.

When recording is not performed on a second side opposite to the first side of the medium, that is, when double-sided recording is not performed, the medium is sent from the transport roller pair 35 to the transport roller pair 36 and discharged toward a discharge tray 8 through a discharge path T4. The discharge path T4 is provided with a transport roller pair 38 and a transport roller pair 39.

When recording is performed on both the first side and the second side opposite to the first side of the medium, that is, when the double-sided recording is performed, the medium is sent from the transport roller pair 35 to the transport roller pair 40 and enters a switchback path T2. Thereafter, a rotation direction of the transport roller pair 40 is switched, the medium enters a reversal path T3, and is sent to the transport roller pair 34 by transport roller pairs 41, 42, and 43.

Reference signs 10A and 10B denote ink accommodation portions serving as liquid accommodation portions that accommodate ink before ejection. The ink ejected from the line head 12 is supplied from the ink accommodation portions 10A and 10B to the line head 12 via tubes (not illustrated). The ink accommodation portion 10A accommodates a black ink as an example. The ink accommodation portion 10B accommodates the yellow, magenta, and cyan inks as an example.

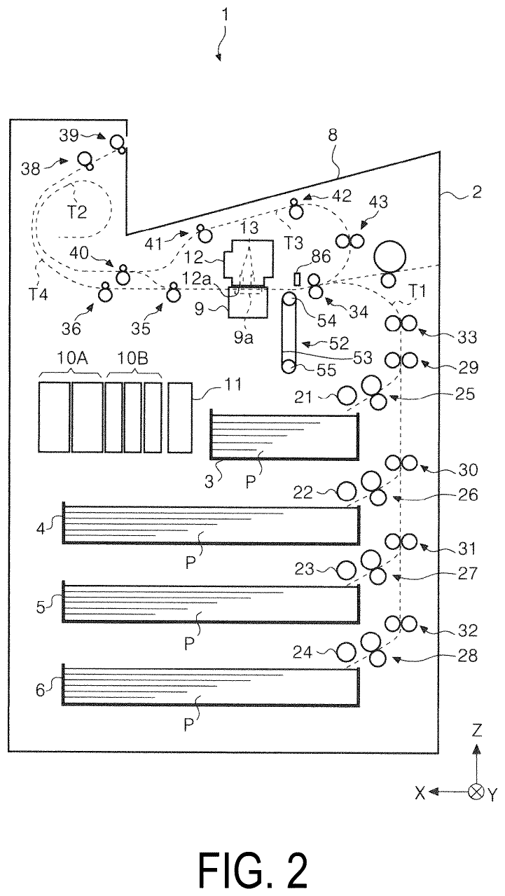

Reference sign 9 denotes a cap unit including a cap portion 9a that caps the line head 12. The cap unit 9 is provided so as to be displaceable by a power source (not illustrated) between a separated position (see FIG. 1) where the cap portion 9a is separated from the line head 12 and a cap position (see FIG. 2) where the cap portion 9a caps a head surface 12a of the line head 12.

Reference sign 11 denotes a waste liquid storage portion that stores ink as a waste liquid ejected from the line head 12 to the cap portion 9a for maintenance. The ink as the waste liquid ejected from the line head 12 toward the cap portion 9a for maintenance is sent from the cap portion 9a to the waste liquid storage portion 11 via a tube (not illustrated).

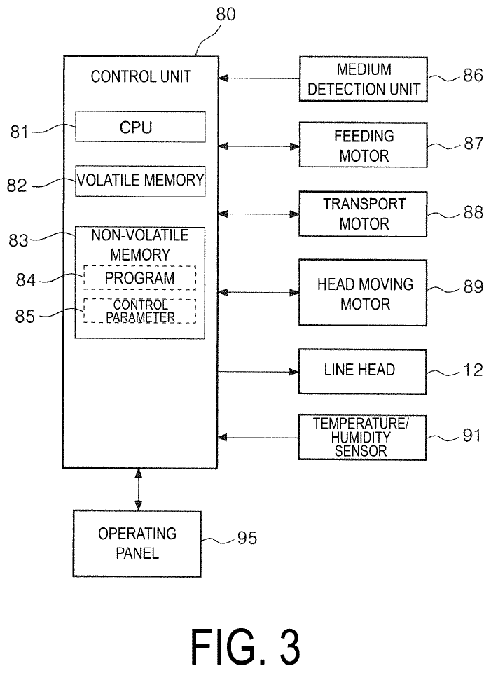

The above is an overview of the overall configuration of the printer 1, and a control unit 80 will be described later with reference to FIG. 3.

The control unit 80 performs various types of control including a recording control in the printer 1. Note that FIG. 3 illustrates only constituent elements necessary for the following description, and does not illustrate other constituent elements. A feeding motor 87, a transport motor 88, a head moving motor 89, and the line head 12 as an output system are electrically coupled to the control unit 80.

The feeding motor 87 is a power source for each pick roller and each feed roller pair described above. Further, the transport motor 88 is a power source for each transport roller pair described above.

Further, the head moving motor 89 is a power source for causing the line head 12 to advance and retreat with respect to the transporting belt 53. That is, the line head 12 is provided so as to be displaceable in the Z-axis direction by a guide portion (not illustrated), that is, in advancing and retreating directions with respect to the transporting belt 53. The, the line head 12 is configured to advance and retreat with respect to the transporting belt 53 by a rack and pinion mechanism (not illustrated) that is operated by power of the head moving motor 89. The above rack and pinion mechanism can be configured by, for example, a rack (not illustrated) provided at the line head 12 and a pinion (not illustrated) rotated by the power of the head moving motor 89.

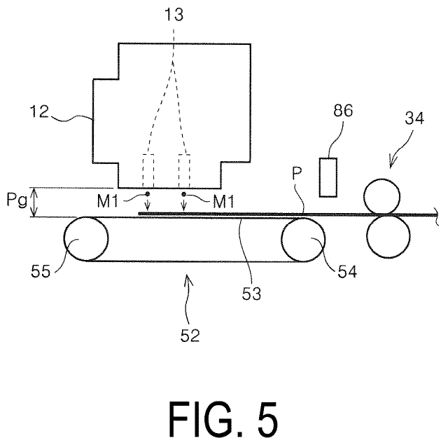

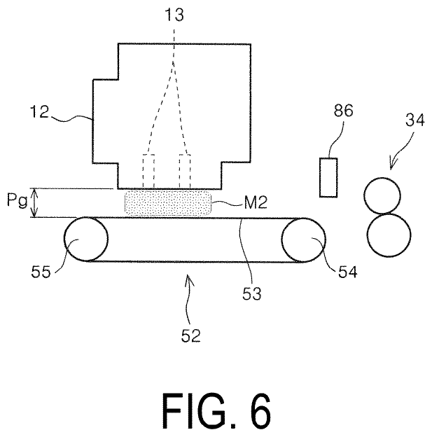

By controlling the head moving motor 89, the control unit 80 can adjust an interval (denoted by a reference sign Pg in FIGS. 5 and 6) between the line head 12 and the transporting belt 53. Hereinafter, this interval is referred to as a gap Pg.

Each of the above motors is a DC motor as an example. Each of the above motors is provided with a rotary encoder (not illustrated), and the control unit 80 can detect a rotation direction, rotation amount, and rotation speed of each of the above motors using the rotary encoder. That is, the control unit 80 can detect a drive direction, drive amount, and drive speed of each driven object.

Additionally, as an input system, an operating panel 95, a medium detection unit 86, and a temperature/humidity sensor 91 are electrically coupled to the control unit 80. The operating panel 95 is a unit that receives power on/off of the printer 1, various settings, recording performance, and the like, and can be configured by a touch panel in which a user interface is achieved by control of the control unit 80, for example.

As illustrated in FIG. 1, the medium detection unit 86 is disposed between the transport roller pair 34 and the line head 12. As an example, the medium detection unit 86 is an optical sensor including a light-emitting unit that emits detection light and a light-receiving unit that receives a reflected component out of the detection light. Based on detection information from the medium detection unit 86, the control unit 80 can detect that a leading end of the medium reaches a position of the medium detection unit 86 or that a trailing end of the medium passes the position of the medium detection unit 86.

The temperature/humidity sensor 91 serves as both a temperature detector for detecting a temperature in the device and a humidity detector for detecting a humidity in the device. In the embodiment, the temperature/humidity sensor 91 is provided at the line head 12 and detects a temperature and a humidity around the line head 12 and the transporting belt 53 facing the line head 12.

The control unit 80 includes a CPU 81 that executes a computer program, in other words, software, a volatile memory 82, and a non-volatile memory 83. The CPU 81 executes various calculations required to execute a program 84 stored in the non-volatile memory 83. The volatile memory 82 is used as a temporary data storage area. The non-volatile memory 83 stores the program 84 and control parameters 85 required to execute the program 84. The program 84 includes a program that executes various types of processing to be described later, and the control parameters 85 include parameters for executing the program 84. The various types of processing to be described later are achieved by the control unit 80 executing the program 84.

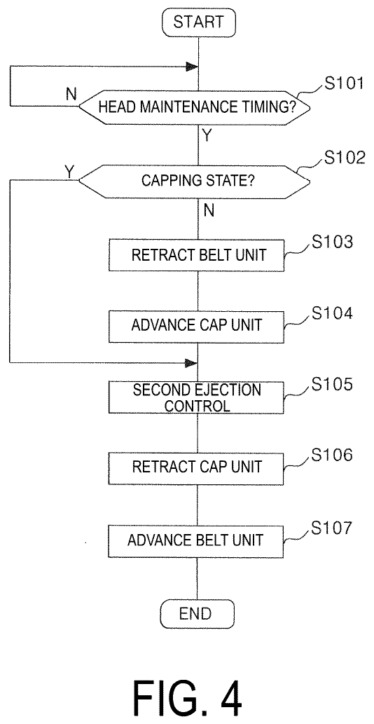

Next, head maintenance will be further described with reference to FIG. 4.

When the control unit 80 determines that head maintenance timing is reached (Yes in step S101), the control unit 80 determines whether a capping state is caused (step S102). The capping state is a state in which the cap portion 9a of the cap unit 9 covers the head surface 12a of the line head 12 as illustrated in FIG. 2. In a case of the capping state (Yes in step S102), processing proceeds to step S105 described later.

In a case of a non-capping state (No in step S102), the control unit 80 causes the belt unit 52 to retreat from a position facing the line head 12 as illustrated as a change from FIG. 1 to FIG. 2 (step S103). Next, the cap unit 9 is caused to advance to a position so as to cover the head surface 12a of the line head 12 as illustrated as the change from FIG. 1 to FIG. 2 (step S104). Then, the control unit 80 performs a second ejection control for causing an ink droplet to be ejected from the line head 12 (step S105). The second ejection control is ink ejection operation for the purpose of eliminating clogging of the nozzle 13. Note that when the second ejection control is performed, the cap portion 9a may be separated from the head surface 12a as long as the cap portion 9a faces the head surface 12a.

Note that the head maintenance timing (step S101) can be set to, for example, at least one of a power-on time, a power-off time, a recorded data reception time, that is, a time before a recording job is started, a time after a recording job is started, and a time after a predetermined time elapses from previous maintenance.

In addition, a size of the ink droplet ejected in the second ejection control (step S105) may be the same as, larger than, or smaller than a size of an ink droplet ejected when a first ejection control described later, that is, recording is performed. However, in the embodiment, the size of the ink droplet ejected in the second ejection control is smaller than a size of an ink droplet when a third ejection control described later is performed.

Next, when the second ejection control is completed, the control unit 80 causes the cap unit 9 to retreat from a position facing the line head 12 as illustrated as a change from FIG. 2 to FIG. 1 (step S106), and causes the belt unit 52 to advance to the position facing the line head 12 as illustrated in FIG. 1 (step S107).

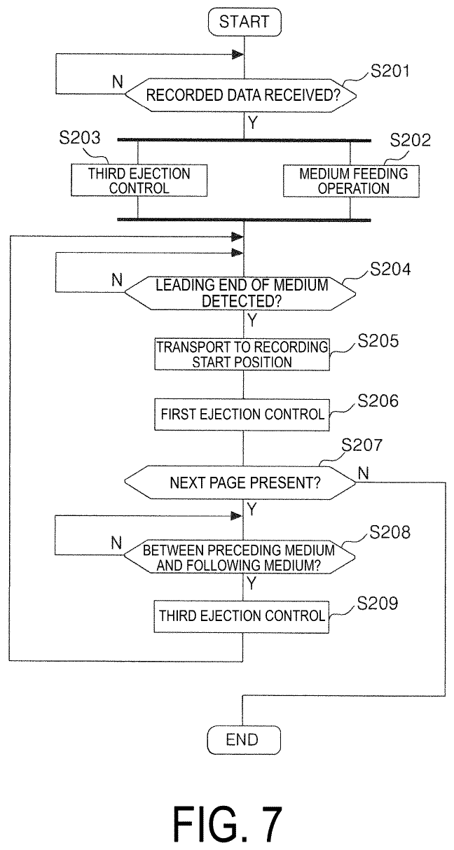

Next, processing performed by the control unit 80 when recorded data is received will be described with reference to FIG. 7. The recorded data is transmitted from, for example, an external computer coupled to the printer 1 to the control unit 80.

When the control unit 80 receives the recorded data (Yes in step S201), the control unit 80 performs the third ejection control (step S203) in parallel with medium feeding operation (step S202). The medium feeding operation is operation for feeding a medium from any one of the first medium cassette 3, the second medium cassette 4, the third medium cassette 5, and the fourth medium cassette 6.

The third ejection control is operation for ejecting an ink droplet from the line head 12.

Hereinafter, the third ejection control (steps S203 and S209) and the first ejection control (step S206) will be described in detail. FIG. 5 is a diagram for explaining the first ejection control. The first ejection control is an ink ejection control when recording is performed on the medium, to eject an ink droplet M1 to cause the ink droplet M1 to land on the medium. On the other hand, FIG. 6 is a diagram for explaining the third ejection control. The third ejection control is a different control from the first ejection control and the second ejection control described above, and is control for turning ink into mist between the line head 12 and the transporting belt 53. In FIG. 6, a reference sign M2 denotes ink mist.

Although the third ejection control will be described in detail later, a humidity above the transporting belt 53 can be increased by performing the third ejection control.

Referring back to FIG. 7, when the medium detection unit 86 detects a leading end of the medium (Yes in step S204), the control unit 80 transports the medium to a recording start position (step S205), performs the first ejection control (step S206), and performs recording on the medium. Then, when there is no next page (No in step S207), the processing ends. When there is a next page (Yes in step S207), the third ejection control is performed (step S209) between a preceding medium and a following medium (step S208). “Between the preceding medium and the following medium” means that the preceding medium is downstream of the line head 12 and the following medium is upstream of the line head 12.

After the third ejection control (step S209) is performed, the processing returns to step S204. Note that in FIG. 7, discharge processing after printing on the medium and transport processing when double-sided printing is performed are not illustrated.

As described above, the control unit 80 can perform, as control for ejecting ink from the line head 12, the first ejection control for performing recording on the medium and the second ejection control being different from the first ejection control for performing maintenance of the line head 12. Further, the control unit 80 can perform the third ejection control being a different control from the first ejection control and the second ejection control for turning the ink into mist between the line head 12 and the transporting belt 53. Further, when the control unit performs the third ejection control, the control unit 80 performs the third ejection control before feeding the medium between the transporting belt 53 and the line head 12.

In other words, the printer 1 can perform, as a liquid ejecting method, first ejection processing for performing recording on the medium and second ejection processing being different processing from the first ejection processing for performing maintenance of the line head 12. Further, the printer 1 can perform third ejection processing being different processing from the first ejection processing and the second ejection processing for turning the ink into mist between the line head 12 and the transporting belt 53. Then, when the printer 1 performs the third ejection processing, the printer 1 performs the third ejection processing before feeding the medium between the line head 12 and the transporting belt 53.

The humidity above the transporting belt 53 can be increased by the third ejection control or the third ejection processing as described above, and thus it is possible to prevent minute matter adhering to the medium from flying up and adhering to the nozzle 13. Then, a configuration for ejecting liquid separately from the line head 12 in order to obtain such an effect is not necessary, and thus it is possible to suppress an increase in size and cost of the device.

In addition, in the above-described embodiment, when recording is performed on the preceding medium, that is, a first medium, and on the following media, that is, a second medium following the first medium, the control unit 80 performs the third ejection control between the preceding medium and the following medium (steps S208 and S209 in FIG. 7). That is, the third ejection control is performed in a state in which the first medium is located downstream in the transport direction with respect to the gap between the line head 12 and the transporting belt 53 and the second medium is located upstream in the transport direction with respect to the gap between the line head 12 and the transporting belt 53.

Accordingly, when recording is performed on a plurality of the media, it is possible to prevent minute matter adhering to the media from flying up and adhering to the nozzle 13.

In addition, the control unit 80 performs the third ejection control by using a time from when the recorded data is received until when the leading end of the first fed medium reaches between the transporting belt 53 and the line head 12 (steps S202 and S203 in FIG. 7). In this way, the third ejection control is performed using the time from when the recorded data is received until when the leading end of the first fed medium reaches between the transporting belt 53 and the line head 12, it is possible to suppress a decrease in recording throughput due to the performance of the third ejection control.

The third ejection control will be further described below.

First, a method of turning the ink ejected by the third ejection control into mist between the line head 12 and the transporting belt 53 will be described.

Turning the ink into mist between the line head 12 and the transporting belt 53 can be achieved by making an ink droplet to be ejected smaller than an ink droplet to be ejected in the first ejection control and an ink droplet to be ejected in the second ejection control. According to such a method, it is possible to appropriately increase the humidity above the transporting belt 53 when the third ejection control is performed.

Note that as the gap Pg (see FIG. 6) is increased, an ejected ink droplet is more likely to be turned into mist without reaching the transporting belt 53. Therefore, by making the gap PG when the third ejection control is performed larger than the gap PG when the first ejection control is performed, the control unit 80 can turn the ink into mist between the line head 12 and the transporting belt 53.

According to such a method, the ink is easily turned into mist between the line head 12 and the transporting belt 53, and the humidity above the transporting belt 53 can be appropriately increased.

Note that in addition to increasing the gap Pg as described above, the ink droplet ejected in the third ejection control may be made smaller than the ink droplet ejected in the first ejection control and the ink droplet ejected in the second ejection control.

Further, as an ejection speed of an ink droplet is lowered, the ejected ink droplet is more likely to be turned into mist. Therefore, an ejection speed of the ink droplet when the third ejection control is performed may be set lower than an ejection speed of the ink droplet when the first ejection control is performed.

Further, from among the increase in the gap Pg, the decrease in the size of the ink droplet, and the decrease in the ejection speed of the ink droplet as described above, any two or all may be employed.

Further, the third ejection control may be performed unconditionally or may be performed conditionally. For example, when the third ejection control is performed conditionally, processing of determining whether to perform the third ejection control or not is added before step S203 and step S209 in FIG. 7.

As an example, the control unit 80 may perform the third ejection control only when a humidity acquired by the temperature/humidity sensor 91 is lower than a predetermined threshold value. In this case, since the third ejection control is not performed when the humidity exceeds the threshold value, that is, in a high humidity environment in which minute matter adhering to the medium is unlikely to fly up, it is possible to suppress ink consumption.

In addition, when the first ejection control is performed, the control unit 80 may be capable of switching between ink ejection for achieving a first quality and ink ejection for achieving a second quality higher in definition than the first quality. Then in this case, when the first quality is achieved, the third ejection control need not be performed, and when the second quality is achieved, the third ejection control may be performed. As an example, the first quality is displayed as “normal” in a print quality selection menu on a printer driver and the second quality is displayed as “high image quality”. As an example, the second quality is higher in print resolution than the first quality.

That is, in a case where the second quality being relatively higher in definition than the first quality is achieved, when dot omission occurs, the dot omission is likely to be conspicuous. Therefore, by not performing the third ejection control when the first quality is achieved, and performing the third ejection control when the second quality is achieved, the second quality can be appropriately achieved. In addition, since the third ejection control is not performed when the first quality is achieved, it is possible to suppress the ink consumption.

In addition, the control unit 80 may determine whether to perform the third ejection control or not according to type information of the medium included in received recorded data. Dot omission caused by minute matter adhering to the medium flying up and adhering to the nozzle 13 is more conspicuous in a case of glossy paper than in a case of plain paper. Therefore, it is also suitable that the third ejection control is performed when a type of the medium is, for example, glossy paper, and the third ejection control is not performed when the type of medium is, for example, plain paper.

In addition, a configuration may be adopted in which in a case where the third ejection control is performed only when a humidity acquired by the temperature/humidity sensor 91 is lower than a predetermined threshold value, the threshold value is changed conditionally.

For example, a threshold value when the temperature acquired by the temperature/humidity sensor 91 is a first temperature is defined as a first threshold value, and a threshold value when the temperature is higher than the first temperature is defined as a second threshold value. In this case, the first threshold value is lower than the second threshold value. This is because, since an amount of moisture contained in air increases as temperature increases even at the same relative humidity, a need for humidification decreases as the temperature increases. Then, the control unit 80 uses a threshold value according to the temperature detected by the temperature/humidity sensor 91. Note that the threshold value for the temperature may be stored as data in the non-volatile memory 83 (see FIG. 3) in advance, or may be calculated by the control unit 80 each time in accordance with a predetermined calculation formula. In this way, by reducing opportunities for the humidification as the temperature increases, unnecessary humidification can be suppressed and an ink consumption amount can be suppressed.

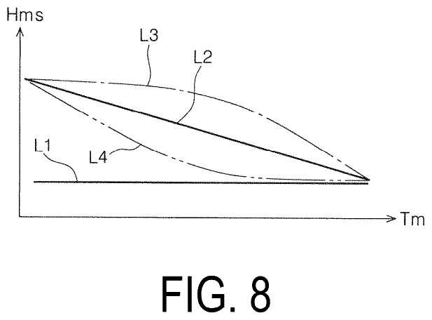

FIG. 8 is a diagram showing an example of a relationship between a threshold value Hms of humidity and temperature Tm. Note that a line L1 is an example of the threshold value Hms that does not depend on the temperature Tm.

A line L2 is an example in which the relationship between the threshold value Hms and the temperature Tm is linear, and a line L3 and a line L4 are examples in which the relationship between the threshold value Hms and the temperature Im is linear. Note that the line L2 is indicated by a solid line, the line L3 is indicated by a one-dot chain line, and the line L4 is indicated by a two-dot chain line. Any of the lines L2, L3, and L4 may be used for the threshold value Hms for the temperature Im. Note that when the line L3 is adopted, since a variation of the threshold value Hms is gentle in a low temperature range, the number of cases in which the transporting belt 53 is humidified in the low temperature range is increased, and the humidity above the transporting belt 53 is more reliably increased. In addition, when the line L4 is adopted, since the variation of the threshold value Hms is large in the low temperature range, the number of cases in which the humidification is performed in the low temperature range is decreased, and the ink consumption amount can be suppressed.

Further, when an ink ejection amount in the third ejection control when a humidity is a first humidity is defined as a first ink ejection amount, an ink ejection amount in the third ejection control when the humidity is a second humidity lower than the first humidity is defined as a second ink ejection amount, and the second ejection amount may be set to be larger than the first ejection amount. Then, a configuration may be adopted in which the control unit 80 uses an ink ejection amount according to a humidity detected by the temperature/humidity sensor 91 in the third ejection control.

Thus, an appropriate ink ejection amount according to the humidity is used. Therefore, it is possible to appropriately increase the humidity above the transporting belt 53.

The ink ejection amount may be adjusted with a single color of ink, or may be adjusted by increasing the number of ink colors to be used. For example, humidity threshold values H1 and H2 (H1<H2) for ink ejection amount adjustment are set. Then, when a detected humidity Hs<the humidity threshold value H1, only the yellow ink is used. In addition, when the humidity threshold value H1≤the detected humidity Hs≤the humidity threshold value H2, any one or both of the cyan ink and the magenta ink are used in addition to the yellow ink. In addition, when the humidity threshold value H2<the detected humidity Hs, all of the yellow, magenta, cyan, and black inks are used. Accordingly, an appropriate ink ejection amount according to the humidity is used, and the humidity above the transporting belt 53 can be appropriately increased.

In addition, when the third ejection control is performed, the control unit 80 can also perform the third ejection control by using a color of ink having a largest moisture amount among the plurality of colors of ink. In this way, it is possible to appropriately increase the humidity above the transporting belt 53.

In addition, when the line head 12 is configured to be able to eject a plurality of colors of ink including yellow from the different nozzles 13, the control unit 80 can also perform the third ejection control by using the yellow ink among the plurality of colors of ink. That is, when ink turns into mist, floats, and adheres to a component portion in the device, the portion is likely to be conspicuous as dirt. By performing the third ejection control by using the yellow ink among the plurality of colors of ink, even when the ink adheres to a component portion in the device, it is possible to make the ink inconspicuous as dirt.

In addition, the control unit 80 can perform the third ejection control by using the nozzle 13 having a long non-ejection period among the plurality of nozzles 13. Thus, clogging of the nozzle 13 can be suppressed.

Note that the nozzle 13 having a long non-ejection period among the plurality of nozzles 13 may be the nozzle 13 having a long non-ejection period among a plurality of the nozzles 13 ejecting a single color, or may be the nozzle 13 of a color having a long non-ejection period among a plurality of the nozzles 13 ejecting different colors.

The present disclosure is not limited to the embodiments and modifications described above, and it is obvious that various modifications are possible within the scope of the disclosure described in the claims, and these are also included in the scope of the present disclosure.

What is claimed is:

1. A liquid ejecting device, comprising:
a support portion configured to support a medium;
a liquid ejecting unit including a plurality of nozzles from which liquid is ejected onto the medium supported by the support portion;
a transport unit configured to transport the medium between the support portion and the liquid ejecting unit; and
a control unit configured to control the liquid ejecting unit and the transport unit, wherein
the control unit is configured to perform, as control for ejecting the liquid from the liquid ejecting unit,
a first ejection control for performing recording on the medium,
a second ejection control for performing maintenance of the liquid ejecting unit, the second ejection control being a different control from the first ejection control, and
a third ejection control for turning the liquid into mist between the liquid ejecting unit and the support portion, the third ejection control being a different control from the first ejection control and the second ejection control, and
the control unit is configured to further performs, when performing the third ejection control, the third ejection control before feeding the medium between the support portion and the liquid ejecting unit.

2. The liquid ejecting device according to claim 1, comprising a humidity detector configured to detect a humidity inside the device, wherein
the control unit performs the third ejection control when a humidity acquired by the humidity detector is lower than a predetermined threshold value.

3. The liquid ejecting device according to claim 1, wherein
the control unit is configured to switch between
liquid ejection for achieving a first quality and
liquid ejection for achieving a second quality higher in definition than the first quality, and
further, the control unit does not perform the third ejection control when achieving the first quality, and performs the third ejection control when achieving the second quality.

4. The liquid ejecting device according to claim 1, wherein when performing recording on a first medium and a second medium following the first medium, the control unit performs the third ejection control in a state in which the first medium is located downstream from between the liquid ejecting unit and the support portion in a transport direction, and the second medium is located upstream from between the liquid ejecting unit and the support portion in the transport direction.

5. The liquid ejecting device according to claim 1, wherein
the control unit performs the third ejection control by using a time from when recorded data is received to when a leading end of a medium first fed reaches between the support portion and the liquid ejecting unit.

6. The liquid ejecting device according to claim 1, wherein
a droplet ejected in the third ejection control is smaller than a droplet ejected in the first ejection control and a droplet ejected in the second ejection control.

7. The liquid ejecting device according to claim 1, wherein
an interval between the liquid ejecting unit and the support portion is adjustable under control of the control unit, and
the control unit sets the interval when performing the third ejection control to be larger than the interval when performing the first ejection control.

8. The liquid ejecting device according to claim 2, comprising a temperature detector configured to detect a temperature inside the device, wherein
the threshold value when the temperature is a first temperature is defined as a first threshold value, the threshold value when the temperature is higher than the first temperature is defined as a second threshold value, the first threshold value being lower than the second threshold value, and
the control unit uses the threshold value according to the temperature detected by the temperature detector.

9. The liquid ejecting device according to claim 1, comprising a humidity detector configured to detect a humidity inside the device, wherein
a liquid ejection amount in the third ejection control when the humidity is a first humidity is defined as a first ejection amount, a liquid ejection amount in the third ejection control when the humidity is a second humidity lower than the first humidity is defined as a second ejection amount, the second ejection amount being larger than the first ejection amount, and
the control unit uses the liquid ejection amount according to the humidity detected by the humidity detector in the third ejection control.

10. The liquid ejecting device according to claim 1, wherein
the liquid ejecting unit is configured to eject a plurality of colors of liquid from different nozzles of the plurality of nozzles, and
the control unit performs the third ejection control by using a color of liquid having a largest moisture amount among the plurality of colors of liquid.

11. The liquid ejecting device according to claim 1, wherein
the liquid ejecting unit is configured to eject a plurality of colors of liquid including yellow from different nozzles of the plurality of nozzles, and
the control unit performs the third ejection control by using the yellow liquid among the plurality of colors of liquid.

12. The liquid ejecting device according to claim 1, wherein
the control unit performs the third ejection control by using the nozzle having a long non-ejection period among the plurality of nozzles.

13. A liquid ejecting method for a liquid ejecting device, the device comprising:
a support portion configured to support a medium;
a liquid ejecting unit including a plurality of nozzles from which liquid is ejected onto the medium supported by the support portion; and
a transport unit configured to transport the medium between the support portion and the liquid ejecting unit,
the liquid ejecting method being configured to perform, as processing of ejecting the liquid from the liquid ejecting unit,
first ejection processing for performing recording on the medium,
second ejection processing for performing maintenance of the liquid ejecting unit, the second ejection processing being different processing from the first ejection processing, and
third ejection processing for turning the liquid into mist between the liquid ejecting unit and the support portion, the third ejection processing being different processing from the first ejection processing and the second ejection processing, wherein
when the third ejection processing is performed, the third ejection processing is performed before the medium is fed between the support portion and the liquid ejecting unit.
